(19) United States
(12) Patent Application Publication
(10) Pub. No.: US 2005/0071447 A1
(43) Pub. Date: Mar. 31, 2005

(54) Method, system and program product for testing a server application using a reentrant test application

(75) Inventors: William J. Masek, Bedford, MA (US); Robert W. Schreiber, Elkton, MD (US); Charles R. Smith, Watertown, MA (US); Mary-Anne G. Wolf, North Billerica, MA (US)

Correspondence Address: HOFFMAN WARNICK & D'ALESSANDRO, LLC, 3 E-COMM SQUARE, ALBANY, NY, 12207, US

(73) Assignee: International Business Machines Corporation, Armonk, NY (US)

(21) Appl. No.: 10/670,898

(22) Filed: Sep. 25, 2003

(51) Int. Cl. G06F 15/173; G06F 13/00; G06F 9/44

(52) U.S. Cl. 709/223; 719/328; 717/124

(57) ABSTRACT

Under the present invention, the APIs of a test application loaded on a client are identified and a test script that is capable of invoking the identified APIs is provided. If the test application satisfies reentrancy requirements, the test script is executed, which instantiates a plurality of instances of the test application using threads. Specifically, each instance of the test application corresponds to a separate thread. Because the test application is reentrant, the plurality of instances can run within a single process (e.g., JVM) with each thread being associated with a separate connection to the server on which the server application is loaded.

### BACKGROUND OF THE INVENTION

1. Field of the Invention

The present invention generally relates to a method, system and program product for testing a server application using a reentrant test application. Specifically, the present invention provides an efficient and effective way to test an application running on a server by allowing multiple instances of a test application to be instantiated within a single process on a test machine.

2. Related Art

As the use of computer hardware and software becomes more prevalent, the need for providing improved product testing is increasing. This is especially the case as more applications are implemented in a network environment. More and more applications on clients are connecting directly to server applications using complex and proprietary protocols. Specifically, before a server application is released, it would be advantageous to first test it in a realistic environment. For a server application, proper testing would be to simulate multiple clients or users running the external network application that uses the application as it runs on a server. To do so, a suitable load must be driven against the server.

Heretofore, many approaches have attempted to provide product testing. For example, “record and playback” products such as LOAD RUNNER, RATIONAL ROBOT or APACHE JAKARTA, record actual application traffic and then play it back to the application. Although this approach could be marginally effective for simple traffic flows, much application traffic is more complex. If the application uses a dynamic protocol then the playback tool must parse the network traffic and change the dynamic values to create a valid load. The record/playback tool must implement record and playback modules for each protocol. Another approach spawns a process such as a Java virtual machine (JVM) per test user. However, given the expense in providing multiple processes, this approach does not scale very well. Still yet, another approach is known as the “test bean” approach and involves running application protocol interfaces (APIs) against the server. This approach, however, does not reflect how the application truly functions on the client. As such, realistic user operation is not provided. In addition if the API's do not satisfy the reentrancy requirement then the applications on the test drivers will not act like a single user on the server.

In view of the foregoing, there exists a need for a method, system and program product for testing a server application using a reentrant test application. To this extent, a need exists for a system that can provide realistic simulation of a user operating the application. Further, a need exists for a system that can test the application efficiently.

### SUMMARY OF THE INVENTION

In general, the present invention provides a method, system and program product for testing a server application using a reentrant test application. Specifically, under the present invention, the APIs of the test application are identified and a test script that is capable of invoking the identified APIs is provided in a test application. If the test application satisfies reentrancy requirements, the test script is executed, which instantiates a plurality of instances of the test application using threads. Specifically, each instance of the test application runs in a separate thread. Because the test application is reentrant, the plurality of instances can run within a single process (e.g., JVM) with each thread generating the load of a separate user on the server on which the application is loaded. This provides a realistic simulation of use of the server application by multiple users running the test application.

A first aspect of the present invention provides a method for testing a server application using a reentrant test application, comprising: providing a test application that satisfies reentrancy requirements on a client; and instantiating a plurality of instances of the test application using threads, wherein each of the plurality of instances of the test application run within a single process.

A second aspect of the present invention provides a system for testing a server application using a reentrant test application, comprising an application instantiation system for instantiating a plurality of instances of the test application on a client using threads if the test application satisfies reentrancy requirements, wherein each of the plurality of instances of the test application run within a single process.

A third aspect of the present invention provides a program product stored on a recordable medium for testing a server application using a reentrant test application, which when executed, comprises: program code for instantiating a plurality of instances of a test application on a client using threads if the test application satisfies reentrancy requirements, wherein each of the plurality of instances of the test application run within a single process.

Therefore, the present invention provides a method, system and program product for testing a server application using a reentrant test application.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a system for testing a server application using a reentrant test application according to the present invention.

FIG. 2 depicts a conceptual diagram showing the operation of the system of FIG. 1.

FIG. 3 depicts a conceptual diagram showing the operation of a prior art system for testing a server application,

FIG. 4 depicts a method flow diagram, according to the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a method, system and program product for testing a server application using a reentrant test application. Specifically, under the present invention, the APIs of the test application are identified and a test script that is capable of invoking the identified APIs is provided in a test application. If the test application satisfies reentrancy requirements, the test script is executed, which instantiates a plurality of instances of the test application using threads. Specifically, each instance of the test application runs in a separate thread. Because the test application is reentrant, the plurality of instances can run within a single process (e.g., JVM) with each thread generating the load of a separate user on the server on which the application is loaded. This provides a realistic simulation of use of the server application by multiple users running the test application.

It should be appreciated in advance that the term “server application” is intended to mean any type of computer application program that can be loaded on a server. For example, the server application could be a network application (e.g., a same time meeting application) that runs on a server, and with which users interact through clients. To this extent, the application can be a JAVA-based or other type of application. In any event, the test application on a client that is driving load against the server application should satisfy reentrancy requirements. Specifically, as will be further described below, the present invention will instantiate multiple instances of the test application to test the server application. As such, multiple test applications will be running in the same process, sharing the same services and memory space. Reentrancy prevents the test applications from interfering with each other.

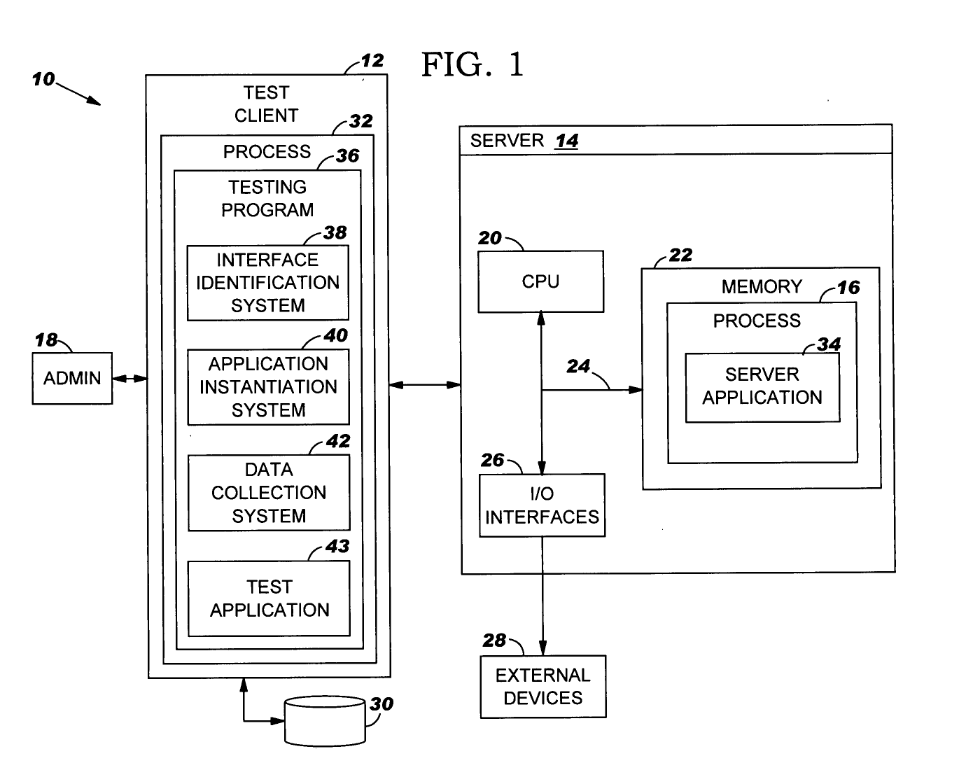

Referring to FIG. 1, a system 10 for testing a server application 34 loaded on a server 14 is shown. Under the present invention, testing program 36 on test client 12 (also referred to as a “driver”) instantiates a plurality of instances of test application 43 using threads so that all of the instances can run within a single process 32 (e.g., JVM). This simulates load from a plurality of users in an efficient manner. To this extent, the teachings of the present invention are typically implemented to simulate a load that would normally occur in a network environment such as the Internet, a wide area network (WAN), a local area network (LAN), a virtual private network (VPN), etc. As known, communication between actual clients and server 14 could occur via a direct hardwired connection (e.g., serial port), or via an addressable connection that may utilize any combination of wireline and/or wireless transmission methods. Server 14 and the clients may utilize conventional network connectivity, such as Token Ring, Ethernet, WiFi or other conventional communications standards. Moreover, connectivity could be provided by conventional TCP/IP sockets-based protocol. In this instance, the clients could utilize an Internet service provider to establish connectivity to server 14.

In any event, as depicted, server 14 generally comprises central processing unit (CPU) 20, memory 22, bus 24, input/output (I/O) interfaces 26 and external devices/resources 28. CPU 20 may comprise a single processing unit, or be distributed across one or more processing units in one or more locations, e.g., on a client and computer system. Memory 22 may comprise any known type of data storage and/or transmission media, including magnetic media, optical media, random access memory (RAM), read-only memory (ROM), a data cache, etc. Moreover, similar to CPU 20, memory 22 may reside at a single physical location, comprising one or more types of data storage, or be distributed across a plurality of physical systems in various forms.

I/O interfaces 26 may comprise any system for exchanging information to/from an external source. External devices/resources 28 may comprise any known type of external device, including speakers, a CRT, LCD screen, hand-held device, keyboard, mouse, voice recognition system, speech output system, printer, monitor/display, facsimile, pager, etc. Bus 24 provides a communication link between each of the components in server 14 and likewise may comprise any known type of transmission link, including electrical, optical, wireless, etc.

Although not shown, additional components, such as cache memory, communication systems, system software, etc., may be incorporated into server 14. Further, it is understood that test client 12 will typically include the same components (e.g., CPU, memory, etc.) as shown and described with reference to server 14. These components have not been separately shown and discussed for brevity.

Shown within process 16 in memory 22 of server 14 is application 34 being tested. In addition, shown within process 32 of test client 12 is testing program 36. As indicated above, and assuming test application 43 is reentrant, testing program 36 will instantiate a plurality of instances of test application 43 using threads within the single process 32. This provides a efficient, cost effective and realistic manner of testing application 34. As shown, testing program 36 includes interface identification system 38, application instantiation system 40 and data collection system 42. Under the present invention, interface identification system 38 will first identify the APIs of test application 43. Once the APIs are identified, a test script that can invoke the APIs can be provided by administrator 18 to the test client 12 or the like and stored in storage unit 30 connected to the client 12. Storage unit 30 can be any system (e.g., database) capable of providing storage for information under the present invention. As such, storage unit 30 could include one or more storage devices, such as a magnetic disk drive or an optical disk drive. In another embodiment, storage unit 30 includes data distributed across, for example, a local area network (LAN), wide area network (WAN) or a storage area network (SAN) (not shown).

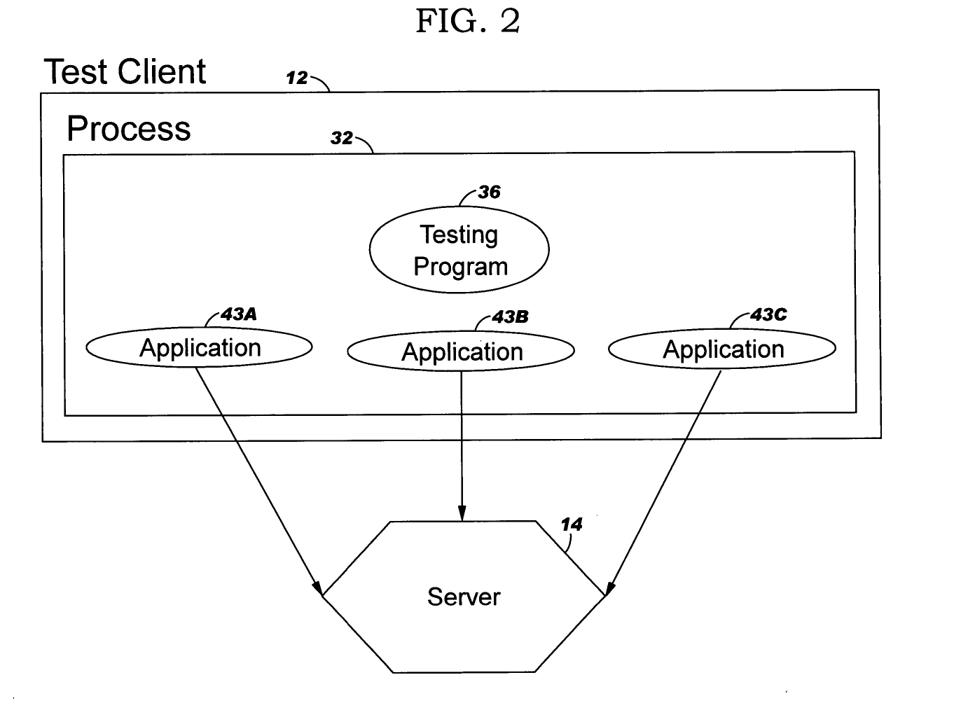

Assuming, the reentry requirements are satisfied, application instantiation system 40 will run the test script to call the APIs and instantiate a plurality of instances of test application 43 using threads. Because test application 43 is reentrant, all of the instances can run with within a single process 32 without interfering with each other. Specifically, each instance of test application 43 that is instantiated corresponds to a separate thread. Each thread in turn is associated with a different connection to server 14. Referring to FIG. 2, this concept is shown in greater detail. Specifically, FIG. 2 depicts a conceptual diagram of the present invention. As depicted, test client 12 will execute the test script, which will cause instances of test application 43A-C to be instantiated. Each instance 43A-C uses a separate thread and runs within process 32. Accordingly, if testing program 36 is attempting to simulate use by 100 users, 100 instances of test application 43 will be instantiated within process 32 using 100 threads and 100 connections to server 14.

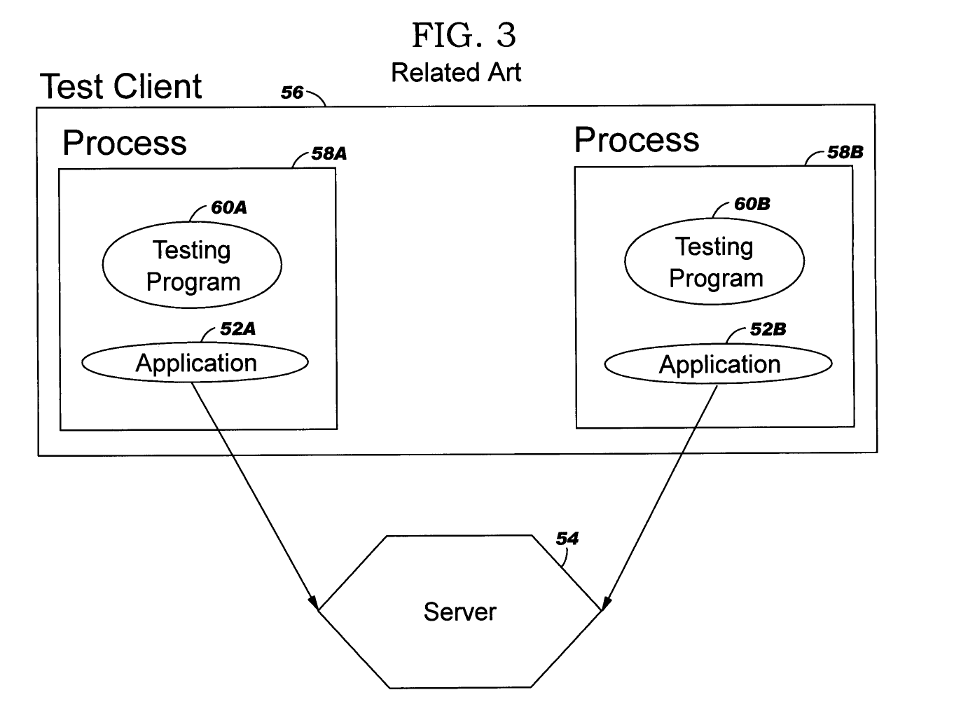

This is in stark contrast to previous methods in which multiple processes were required to instantiate multiple instances of an application. For example, referring to FIG. 3, the concept of the previous method is shown. As depicted, for each instance of application 52A-B that is instantiated by test client 56, a separate process 58A-B and instance of testing program 60A-B must be provided on test client 56. Since each process 58A-B can consume 10-20 megabytes of memory, the method shown in FIG. 3 is costly and inefficient.

Referring back to FIG. 1, as the test is running, data collection system 42 will collect data corresponding thereto. For example data collection system 42 can not only keep track of test specifics such as time and date information, but it can also monitor and track (e.g., in storage unit 30) the quantity and identity of the instances instantiated. This tracking can also include how application 34 performed under test. Administrator 18 can view the results and make any necessary changes to application 34.

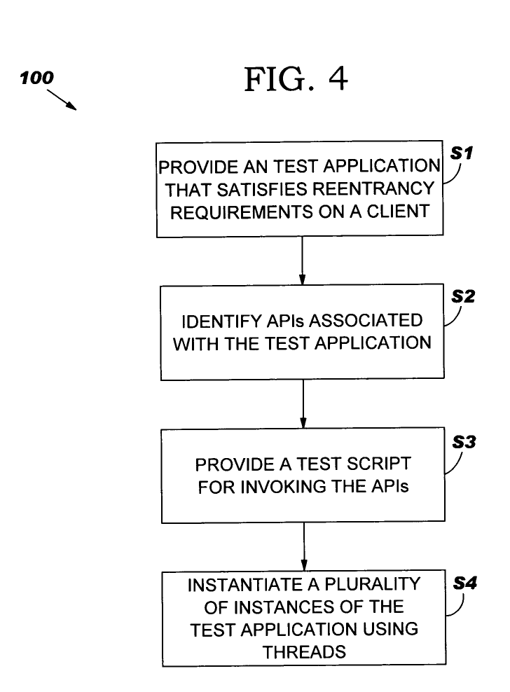

Referring now to FIG. 4 a method flow diagram 100 according to the present invention is shown. As depicted, first step S1 is to provide a test application that meets reentrancy requirements on a client. Second step S2 is to identify APIs associated with the test application. Third step S3 is to provide a test script for invoking the APIs. Fourth step S4 is to instantiate a plurality of instances of the test application using threads. This allows the plurality of instances to effectively run within a single process.

It should be understood that the present invention can be realized in hardware, software, or a combination of hardware and software. Any kind of computer system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A method for testing a server application using a reentrant test application, comprising:
providing a test application that satisfies reentrancy requirements on a client; and
instantiating a plurality of instances of the test application using threads, wherein each of the plurality of instances of the test application run within a single process.

2. The method of claim 1, further comprising:
identifying application protocol interfaces (APIs) associated with the test application, prior to the instantiating step; and
providing a test script capable of invoking the APIs, wherein upon execution, the test script instantiates the plurality of instances of the test application using threads within the single process.

3. The method of claim 1, wherein the server application is a network application.

4. The method of claim 1, wherein the reentrancy requirements dictates that the plurality of instances of the test application be run within the single process without interfering with each other.

5. The method of claim 1, wherein each of the plurality of instances of the test application corresponds to a separate thread, and wherein each of the separate threads is associated with a different connection to the server.

6. The method of claim 1, wherein the process comprises a Java virtual machine.

7. The method of claim 1, wherein the plurality of instances of the test application simulate use of the server application by a plurality of users.

8. The method of claim 1, further comprising collecting data corresponding to the test.

9. A system for testing a server application, comprising an application instantiation system for instantiating a plurality of instances of a test application on a client using threads if the test application satisfies reentrancy requirements, wherein each of the plurality of instances of the test application run within a single process.

10. The system of claim 9, further comprising an interface identification system for identifying application protocol interfaces (APIs) associated with the test application.

11. The system of claim 10, wherein the test application instantiation system comprises a driver that executes a test script capable of invoking the identified APIs, and wherein upon execution, the test script instantiates the plurality of instances of the test application using threads within the single process.

12. The system of claim 9, wherein the reentrancy requirements dictates that the plurality of instances of the test application be run within the single process without interfering with each other.

13. The system of claim 9, wherein each of the plurality of instances of the test application corresponds to a separate thread, and wherein each of the separate threads is associated with a different connection to the server.

14. The system of claim 9, wherein the application is a network application.

15. The system of claim 9, wherein the process comprises a Java virtual machine.

16. The system of claim 9, wherein the plurality of instances of the test application simulate use of the server application by a plurality of users.

17. The system of claim 9, further comprising a data collection system for collecting data corresponding to the test.

18. A program product stored on a recordable medium for testing a server application, which when executed, comprises program code for instantiating a plurality of instances of a test application on a client using threads if the test application satisfies reentrancy requirements, wherein each of the plurality of instances of the test application run a single process.

19. The program product of claim 18, further comprising program code for identifying application protocol interfaces (APIs) associated with the test application.

20. The program product of claim 19, wherein the program code for instantiating executes a test script capable of invoking the identified APIs, and wherein upon execution, the test script instantiates the plurality of instances of the test application using threads within the single process.

21. The program product of claim 18, wherein the reentrancy requirements dictates that the plurality of instances of the test application be run within the single process without interfering with each other.

22. The program product of claim 18, wherein each of the plurality of instances of the test application corresponds to a separate thread, and wherein each of the separates threads is associated with a different connection to the server.

23. The program product of claim 18, wherein the server application is a network application.

24. The program product of claim 18, wherein the process comprises a Java virtual machine.

25. The program product of claim 18, wherein the plurality of instances of the test application simulate use of the server application by a plurality of users.

26. The program product of claim 18, further comprising program code for collecting data corresponding to the test.
